(19) United States
(12) Patent Application Publication
(10) Pub. No.: US 2024/0402001 A1
(43) Pub. Date: Dec. 5, 2024

(54) METHOD OF DETERMINING A USERS BLIND WEIGHT WITH A SPECIALIZED SCALE

(71) Applicant: BLIND WEIGHT LLC, Parkland, FL (US)

(72) Inventor: Vinicius Aschidamini, Parkland, FL (US)

(73) Assignee: BLIND WEIGHT LLC, Parkland, FL (US)

(21) Appl. No.: 18/679,150

(22) Filed: May 30, 2024

Related U.S. Application Data
(60) Provisional application No. 63/469,714, filed on May 30, 2023.

(51) Int. Cl. G01G 19/44; G01G 23/18

(52) U.S. Cl. CPC G01G 19/44; G01G 23/18

(57) ABSTRACT

A method of determining a blind weight of a user with a specialized scale that includes the steps of providing a weight scale with a weight sensor operably configured to ascertain a weight of an object supported on the upper surface, convert the weight to one of a plurality of non-weight identifying electronic symbols uniquely associated with the weight and operably configured to display the non-weight identifying electronic symbol to the electronic display and measuring a user weight from the user with the weight scale, converting the user weight to the one of the plurality of non-weight identifying electronic symbols uniquely associated with the user weight, and displaying the symbol on the electronic display of the weight scale. Next, the process includes electronically communicating symbol to a secondary electronic computing device 500 for decoding.

### FIELD OF THE INVENTION

The present invention relates to weight scales and, more specifically, to a method of obtaining and conveying a user's weight to a secondary party for display and analysis.

### BACKGROUND OF THE INVENTION

Traditional weight scales can create a triggering weigh-in experience for individuals with eating disorders or those who may feel stressed or anxious when using such scales. These traditional scales typically display the user's weight on a screen, offering no sense of privacy or confidentiality. On the other hand, existing “blind” or “numberless” scales are often expensive, prone to exposing the true weight of the user, and rely on an unreliable communication interface and protocol.

Therefore, a need exists to overcome the problems with the prior art as discussed above.

### SUMMARY OF THE INVENTION

The invention provides a method of determining a user's blind weight with a specialized scale that overcomes the hereinafore-mentioned disadvantages of the heretofore-known devices and methods of this general type and that provides a unique method and assembly for coded weight scales. The invention involves the depiction of a symbol, such as a code that includes letters or numbers, images, or QR codes, instead of displaying a traditional numbered weight, providing an alternative way for users to perform and share blind weigh-ins.

The codes can be decoded back into the user's numerical weight value using written directions and algorithms, or through the use of a computing device, such as a web application, desktop, and/or mobile app, that is capable of decoding the code and converting it into a weight value. Additionally, the code can also be decoded by sending a text message to a designated phone number, which will then reply with the corresponding weight value. Furthermore, the scale is equipped to generate a QR code on the display, which can be scanned using a mobile device camera to decode the value back into the weight measurement.

With the foregoing and other objects in view, there is provided, in accordance with the invention, a method of determining a blind weight of a user with a specialized scale comprising the steps of providing a weight scale having a scale body having an upper surface, having an electronic display, having a weight sensor operably configured to ascertain a weight of an object supported on the upper surface of the weight scale body, and operably configured to convert the weight to one of a plurality of non-weight identifying electronic symbols uniquely associated with the weight and operably configured to display the non-weight identifying electronic symbol to the electronic display, providing a secondary electronic computing device with an electronic display configured to display a user interface, measuring a user weight from the user with the weight scale, converting the user weight to the one of the plurality of non-weight identifying electronic symbols uniquely associated with the user weight, and displaying the one of the plurality of non-weight identifying electronic symbols on the electronic display of the weight scale, electronically communicating the one of the plurality of non-weight identifying electronic symbols to the secondary electronic computing device, and inserting the one of the plurality of non-weight identifying electronic symbols into the user interface, decoding the one of the plurality of non-weight identifying electronic symbols into a decoded user weight, and displaying the decoded user weight on the user interface.

In accordance with another feature, an embodiment of the present invention includes providing the weight scale body with a substantially planar upper surface with the electronic display disposed thereon.

In accordance with a further feature of the present invention, each of the plurality of non-weight identifying electronic symbols further comprise at least one of a combination of numbers, a combination of letters, an alphanumerical combination, and a visually perceivable image.

In accordance with yet another feature, an embodiment of the present invention also includes decoding the one of the plurality of non-weight identifying electronic symbols into the decoded user weight with at least one of a processor resident on the secondary electronic computing device and a processor on a remote server and storing the decoded user weight on at least one of a memory resident on the secondary electronic computing device and a memory resident on the remote server.

In accordance with an additional feature, an embodiment of the present invention also includes providing a user electronic computing device communicatively coupled to the secondary electronic computing device over a network and having an electronic display and a user interface, inserting the one of the plurality of non-weight identifying electronic symbols in the user interface of the user electronic computing device, and electronically communicating the one of the plurality of non-weight identifying electronic symbols from the user electronic computing device to the secondary electronic computing device.

In accordance with yet another feature, an embodiment of the present invention also includes storing a plurality of decoded user weights on the at least one of the memory resident on the secondary electronic computing device and the memory resident on the remote server, the secondary electronic computing device operably configured to display a categorized inventory of the plurality of decoded user weights on the user interface of the secondary electronic computing device.

In accordance with a further feature, an embodiment of the present invention also includes providing the weight scale having a networking interface communicatively coupling the weight scale to the electronic computing device through a network and electronically communicating the one of the plurality of non-weight identifying electronic symbols from the weight scale to the electronic computing device.

The present invention also discloses a specialized blind weight scale with a scale body having an upper surface and at least one lower surface configured to support the scale body on a ground surface, an electronic display disposed on the upper surface of the scale body, a weight sensor operably configured to ascertain a weight of an object supported on the upper surface of the weight scale body, and a processor and a memory storing a computer readable instructions for converting the weight to a unique non-weight identifying electronic symbol, wherein the processor is operably configured to convert the weight to the unique non-weight identifying electronic symbol and is operably configured to display the unique non-weight identifying electronic symbol on the electronic display of the scale body.

Although the invention is illustrated and described herein as embodied in a coded weight scale assembly, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Some of the specific objectives of present invention include: (i) providing an affordable and innovative solution to help individuals better manage their weight and achieve their health goals; (ii) offering a user-friendly and easy-to-use scale that does not require users to log in to a portal, use Bluetooth or Wi-Fi connections, or complete any additional registration or connectivity steps; (iii) ensuring privacy and confidentiality by converting weight measurements into a code; (iv) helping to reduce stress and anxiety associated with traditional scales by providing a less-triggering weigh-in experience; (v) supporting healthcare providers by offering an efficient and effective tool for tracking and monitoring their patients' weight measurements; and (vi) continuously improving and updating its product to meet the needs and expectations of its users.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the scale or other referencing structure.

In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 depicts a top plan view of a specialized blind weight scale in accordance with one embodiment of the present invention;

FIG. 2 depicts a front elevational view of the specialized blind weight scale of FIG. 1;

FIG. 3 depicts a side elevational view of the specialized blind weight scale of FIG. 1;

FIG. 4 depicts a block diagram illustrating electrical components utilized with the specialized blind weight scale of FIG. 1 and other electronic computing devices utilized in the process in accordance with one embodiment of the present invention;

FIG. 5 depicts a networking diagram illustrating connectivity of the electrical components utilized with a method of determining a user's blind weight with a specialized scale in accordance with one embodiment of the present invention;

FIGS. 6-10 depict exemplary screenshots from a user interface of a secondary electronic computing device in accordance with embodiments of the present invention; and

FIG. 11 depicts a process flow diagram illustrating a method of determining a user's blind weight with a specialized scale in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

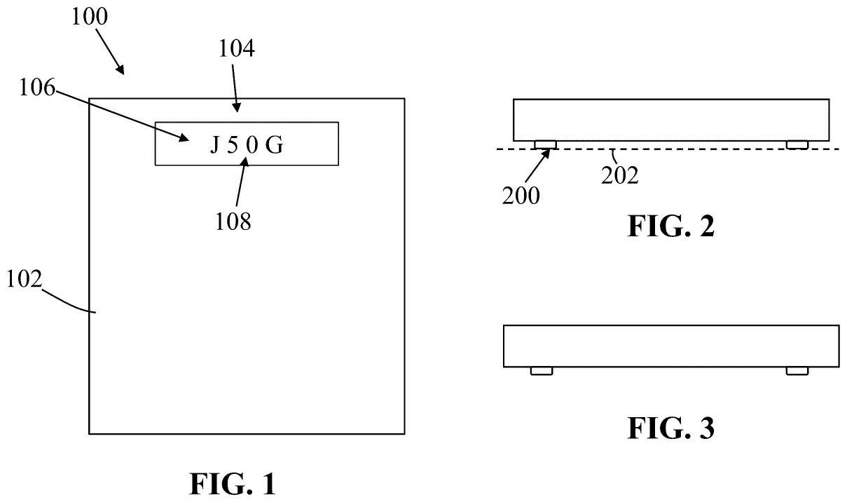

Referring now to FIGS. 1-3, one embodiment of the specialized blind weight scale assembly is depicted. FIGS. 1-3, along with other figures herein, show several advantageous features of the present invention, but, as will be described below, the invention can be provided in several shapes, sizes, combinations of features and components, and varying numbers and functions of the components. The specialized blind weight scale is also referred to herein as the “blind weight scale,” or a unique scale that offers an alternative to traditional weight scales that directly display weight values. Instead of showing numbers, the blind weight scale presents a code comprising a symbol provided to the user during a weigh-in. This symbol serves the purpose of concealing the actual weight numbers from the user. The weighing user can share the generated scale symbol, which can be in any of the aforementioned formats, with others who can decode the symbol to reveal the corresponding weight numeral value.

The blind weight scale brings blind weigh-in accessibility to a wide demographic population, including individuals without smartphones, Bluetooth, Wi-Fi connectivity, or technological expertise. Additionally, users are not required to download software applications, log in to portals, or undergo additional registration or connectivity procedures when using the blind weight scale, whether it is at home or in a clinician's office.

In general, when a user steps on the blind weight scale, it displays a unique symbol instead of the weight, effectively concealing the actual weight measurement. This code represents the user's weight value. The user has the option to share the symbol through various methods to retrieve the weight value encoded within it.

The code can be decoded using different approaches. One method involves following written directions and utilizing a mathematical equation to convert the symbol into a weight value. Alternatively, a computing device such as a web application, desktop, or mobile app can be employed to decode the symbol and provide the corresponding weight value. In addition, the symbol can be decoded by sending a text message containing the symbol to a designated phone number. The designated phone number will then reply with the weight value associated with the symbol.

Furthermore, the blind weight scale is equipped with the capability to generate a QR code (forming the symbol) on its display. Users can scan this QR code using a mobile device camera, which will decode the QR code and reveal the weight value it represents.

The main purpose and objectives of the present invention are to provide an alternative and less triggering weigh-in experience for individuals who may feel stressed or anxious when using traditional scales. The blind weight scale unique coded system ensures privacy and confidentiality while allowing users to secretly track and share weight measurements with their healthcare providers.

Referring now to FIGS. 1-5, the present invention provides a novel, portable, and specialized blind weight scale 100 that includes a substantially rigid scale body 102 having an upper surface 104 and at least one lower surface 200 configured to support the scale body 102 on a ground surface 202 (generally in a level orientation). The scale 100 includes an electronic display 106 disposed on the upper surface 104 of the scale body 102 and a weight sensor 404 operably configured to ascertain a weight of an object (e.g., human user) supported on the upper surface 104 of the weight scale body 102. The scale 100 includes a processor 404 and a memory 406 storing a computer readable instructions (or program) for converting the weight to a unique non-weight identifying electronic symbol, i.e., indicia that does not visually portray the user's actual or measured weight value. The processor 404 is beneficially and operably configured to convert the weight to the unique non-weight identifying electronic symbol, e.g., using a stored database or matrix. The processor 404 is also operably configured to display the unique non-weight identifying electronic symbol on the electronic display 106 of the scale body 102.

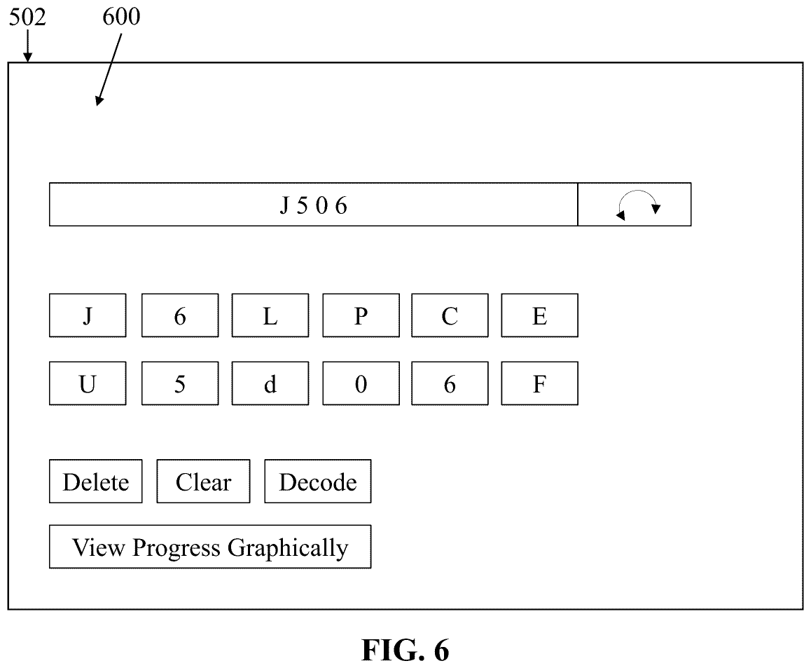

In one embodiment, the weight scale body 102 includes a substantially planar upper surface 104 with the electronic display 106 disposed thereon for accurately measuring the user's weight. The upper surface 104 is substantially planar in that it doesn't have visually perceivable raised edges over the surface area of the upper surface 104 defined by the perimeter of the scale body 102. Substantially planar may also be defined as flat or of, relating to, or lying in a plane. As mentioned above, the plurality of non-weight identifying electronic symbols capable of being generated by the scale 100 include one or more either a combination of numbers, a combination of letters, an alphanumerical combination, and a visually perceivable image (e.g., butterfly, food items, QR code, etc.). In preferred embodiments, the symbol is collection of alphanumeric text consisting of 4-8 characters, wherein the physician will decode those characters with preset list of characters that will partially match the symbol (as best depicted in FIG. 6).

In one embodiment, the scale 100 includes a power source 408, e.g., a battery or power cord with electrical connector, providing power to the electrical components of the scale 100. The scale 100 may also include a networking interface 402 operably configured to communicatively couple the weight scale 100 to an electronic computing device (e.g., a secondary electronic computing device 500 of a physician or remote server 504) through a network 508, wherein the processor 404 is operably configured to electronically communicate the unique non-weight identifying electronic symbol (e.g., symbol 108 in FIG. 1) to the electronic computing device 500 through the network 508. This electronic communication may be done autonomously so the weighing user is unaware of the communication.

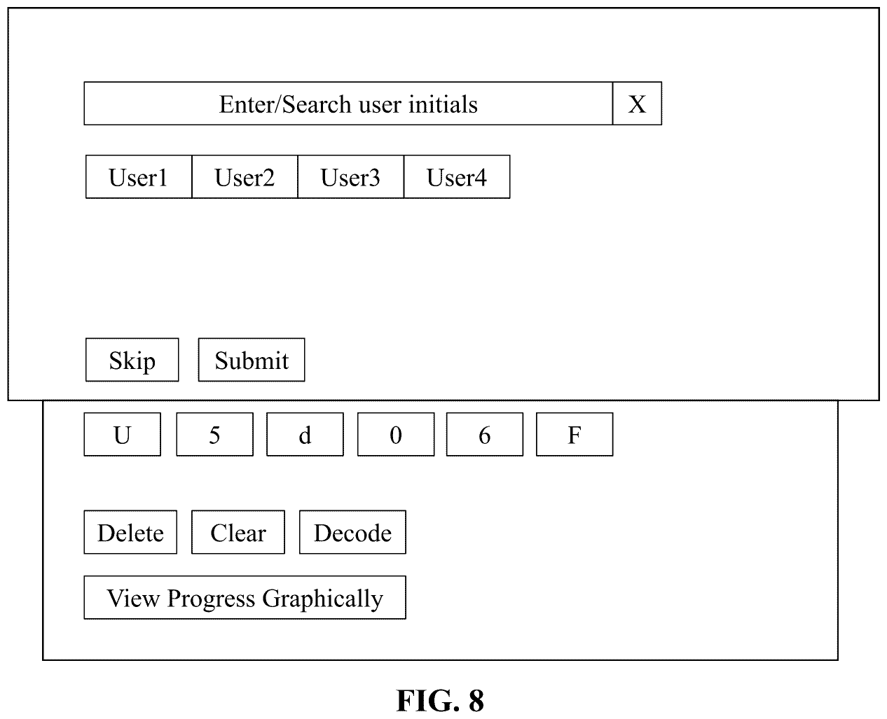

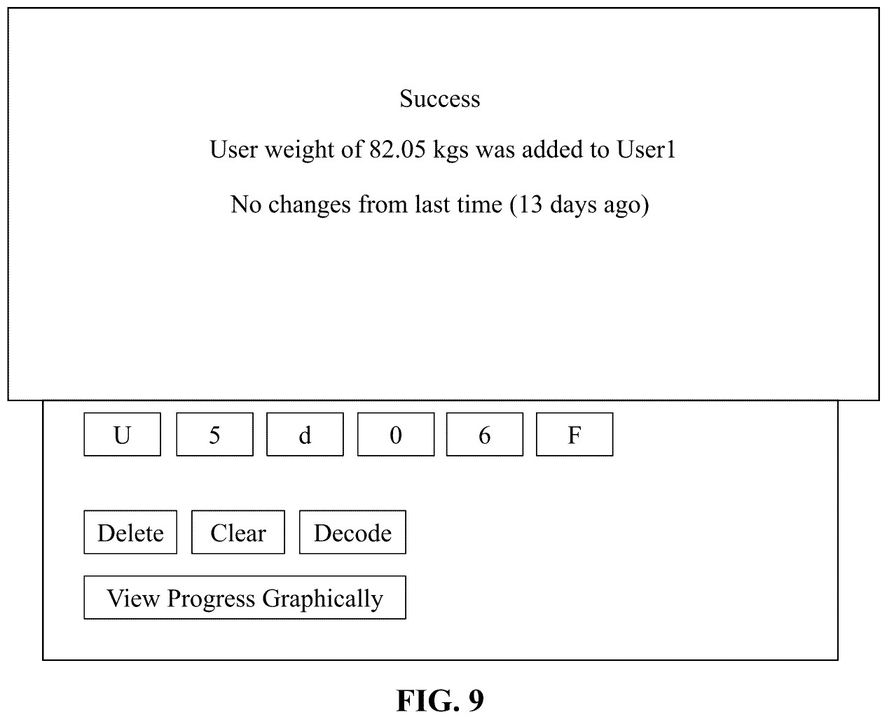

The process of blindly determining a user's weight may include having the user step on the substantially planar upper surface 104 and having the symbol 108 depicted on the electronic display 106 (e.g., code, letter, symbol, image, or QR code) instead of the numbered weight measurement of the user. A secondary user, such as a provider, parent, or third party may access a separate channel (e.g., a web portal, mobile application, or text the coded value to a designated phone number) to view the numbered weight measurement of the user by decoding the symbol 108. The symbol 108 depicted on the display 106 of the scale 100 is entered into the separate channel or interface (shown in FIGS. 6-10) where said symbol 108 is then converted (decoded) into the corresponding numbered weight measurement of the user. Beneficially, this prevents the user from being triggered or having a negative emotional reaction to the numbered weight measurement as the user cannot view the numbered weight measurement on the scale 100 itself. While avoiding the negative effects of weighing, the present invention simultaneously enables medical providers, parents, and caretakers to ensure the user's weight is in a healthy or positive range. In an exemplary embodiment of the present invention, the numbered weight measurement of the user is converted into a unique and dynamic QR code, which the user can scan with their phone camera and send to anyone with access to the separate channel or portal to decode the numbered weight measurement. Additionally, the code can also be decoded by sending a text message to a designated phone number, which will then reply with the corresponding weight value.

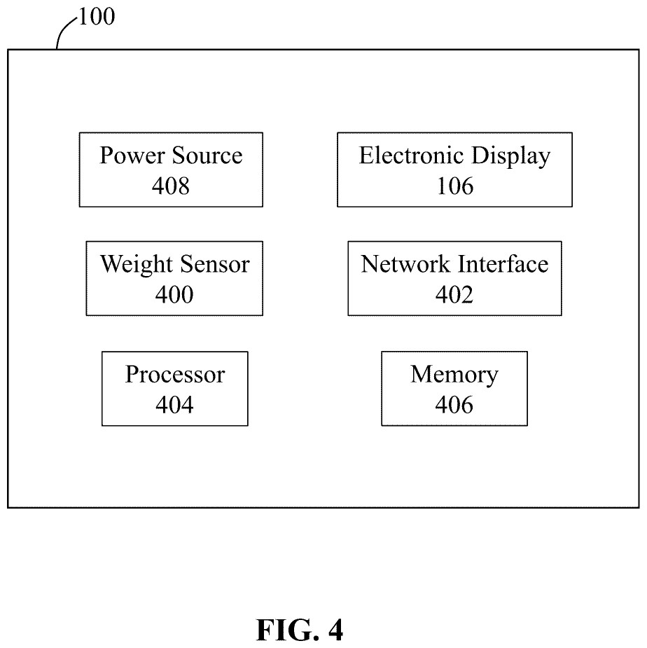

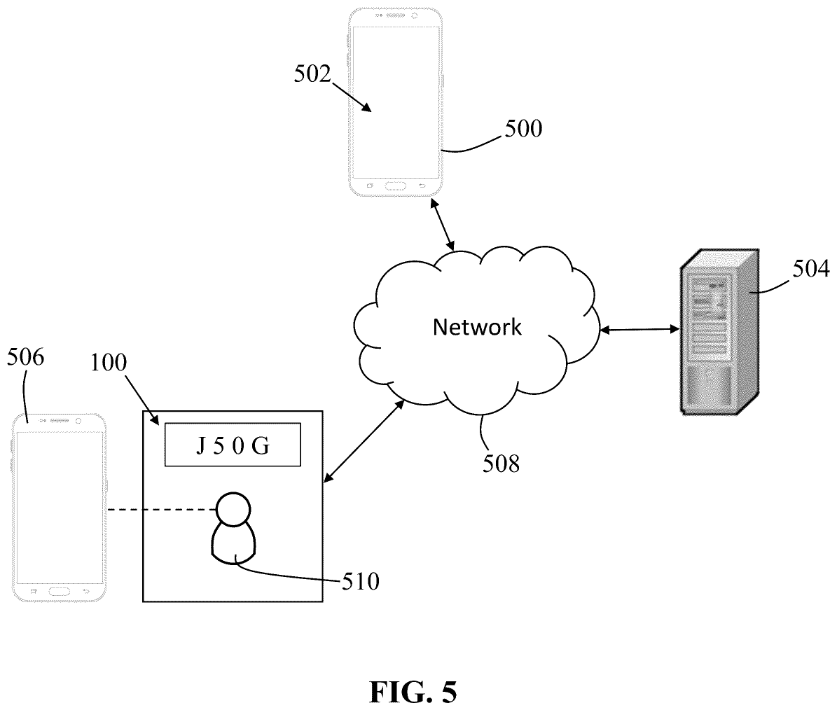

With reference specifically to networking block diagram of FIG. 5, electrical components are depicted for carrying out the present invention and may include the scale 100, a secondary electronic computing device 500, a remote server 504 that is physically remote from the other computing devices, and a user electronic computing device 506 of the weighing user 510. The block diagram depicted in FIG. 4 may represent the structure of other computing devices connected to one another over the network 508. A network interface, like the interface 402 may also include a local area network (LAN) interface. The LAN interface may be, for example, an interface to a wireless LAN, such as a Wi-Fi network. In one embodiment, there is a wireless LAN that provides the input devices with access to the Internet for receiving and sending inputs/messages to a server 504, over the Internet. The range of the LAN interface may generally exceed the range available via the PAN interface. Typically, a connection between two electronic devices via the LAN interface may involve communication through a network router or other intermediary device. Additionally, the network interfaces may include the capability to connect to a wide area network (WAN) via a WAN interface. The WAN interface may permit a connection to a cellular mobile communications network. The WAN interface may include communications circuitry, such as an antenna coupled to a radio circuit having a transceiver for transmitting and receiving radio signals via the antenna. The radio circuit may be configured to operate in a mobile communications network, including but not limited to global systems for mobile communications (GSM), code division multiple access (CDMA), wideband CDMA (WCDMA), and the like.

Memory, like memory 406 associated with the components, may be, for example, one or more buffer, a flash memory, or non-volatile memory, such as random-access memory (RAM). The input devices may also include non-volatile storage. The non-volatile storage may represent any suitable storage medium, such as a hard disk drive or non-volatile memory, such as flash memory. The processor 404 associated with the components is operably configured to receive instruction or carry out instruction and is operably coupled to a non-transitory memory 406. The process 404 may be part of a microcontroller on a single integrated circuit.

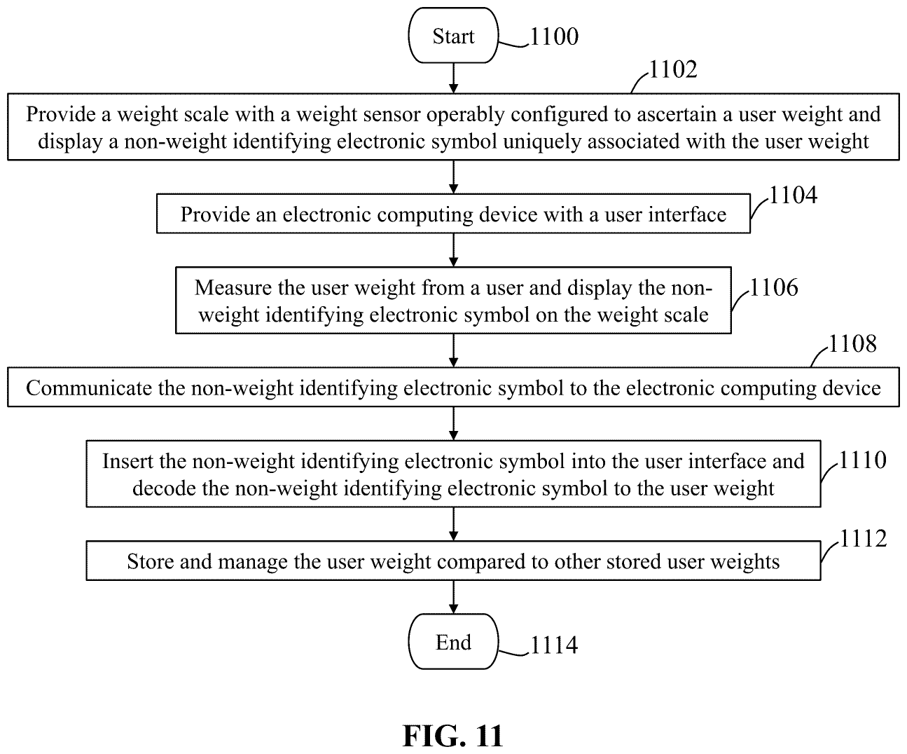

FIGS. 1-10 can also be described in conjunction with the process flow chart of FIG. 11. Although FIG. 11 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 11 for the sake of brevity. In some embodiments, some or all of the process steps included in FIG. 11 can be combined into a single process.

More specifically, a method of determining a blind weight of a user with a specialized scale may begin at step 1100 and proceed to step 1102 of providing a weight scale 100 having a scale body 102 having an upper surface 104, having an electronic display 106, having a weight sensor 400 (e.g., load cell, single point sensor, S-type sensor, etc.), operably configured to ascertain a weight of an object supported on the upper surface 104 of the weight scale body 102, and operably configured to convert the weight to one of a plurality of non-weight identifying electronic symbols uniquely associated with the weight and operably configured to display the non-weight identifying electronic symbol to the electronic display 106. Next, the process may include the step 1104 of providing a secondary electronic computing device 500 with an electronic display 502 configured to display a user interface 600 (exemplified in FIG. 6).

Next, the process proceeds to step 1106 measuring a user weight from the user with the weight scale 100, converting the user weight to the one of the plurality of non-weight identifying electronic symbols uniquely associated with the user weight, and displaying the one of the plurality of non-weight identifying electronic symbols on the electronic display 106 of the weight scale 100 (best depicted in FIG. 1). Again, the symbol 108 may also include a mark or character used as a conventional representation of an object, function, or process, e.g. the letter or letters, shapes.

Thereafter, the process includes the step 1108 of electronically communicating the one of the plurality of non-weight identifying electronic symbols to the electronic computing device 500. In one embodiment, a user electronic computing device 506 is provided and communicatively coupled to the secondary electronic computing device 500 over a network and also has an electronic display with a user interface (as exemplified in FIG. 5). The user 510 will insert the one of the plurality of non-weight identifying electronic symbols in the user interface of the user electronic computing device 506 and electronically communicate said one of the plurality of non-weight identifying electronic symbols from the user electronic computing device 506 to the secondary electronic computing device 500 for decoding. In one embodiment, the process includes providing the weight scale 100 with a networking interface 402 communicatively coupling the weight scale 100 to the electronic computing device 500 through a network and electronically communicating the one of the plurality of non-weight identifying electronic symbols from the weight scale 100 to the electronic computing device 500.

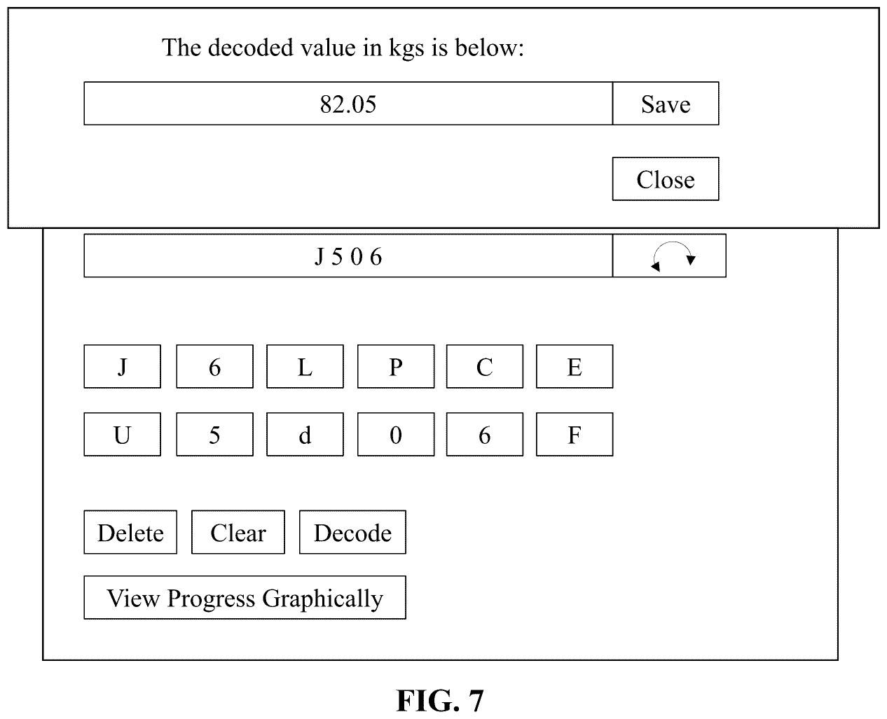

Next, as seen in FIGS. 6-10, the process may proceed to step 1110 of inserting the one of the plurality of non-weight identifying electronic symbols into the user interface 600 of the secondary computing device 500, decoding said one of the plurality of non-weight identifying electronic symbols into a user weight (best seen in FIG. 7), and displaying the user weight on the user interface 600. In one embodiment, the process may include decoding said one of the plurality of non-weight identifying electronic symbols into the decoded user weight with one or both of a processor resident on the secondary electronic computing device 500 and/or a processor on a remote server 504. To expedite processing, the decoding may be done on the device 500. The process may also include storing the decoded user weight on either or both of a memory resident on the secondary electronic computing device 500 and a memory resident on the remote server 504.

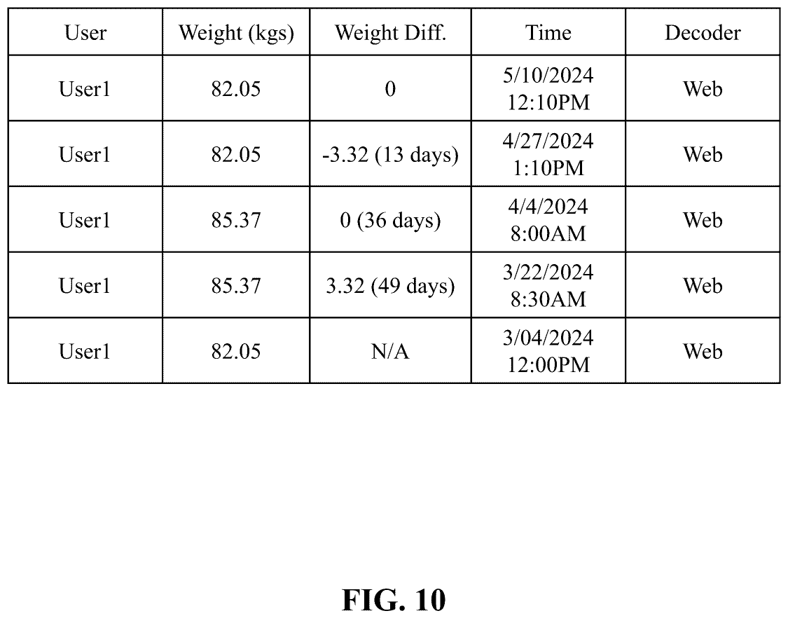

Next, the process may proceed to step 1112 of storing and managing the decoded user weight compared to other stored decoded user weights. Said another way, the process includes storing a plurality of decoded user weights on either or both the memory resident on the secondary electronic computing device 500 and/or the memory resident on the remote server 504, wherein the secondary electronic computing device 506 is operably configured to display a categorized inventory of the plurality of decoded user weights on the user interface of the secondary electronic computing device 500 (best seen in FIG. 10). As seen in FIG. 10, the user interface of the secondary user may be operably configured to display multiple users with weight information, wherein FIG. 10 specifically depicts decoded values over a period of time, differences between the same, time stamps when the weight is ascertained or when the symbol is received, and how decoded (e.g., through a web-based portal or through a software application).

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

What is claimed is:

1. A method of determining a blind weight of a user with a specialized scale comprising the steps of:
providing a weight scale having a scale body having an upper surface, having an electronic display, having a weight sensor operably configured to ascertain a weight of an object supported on the upper surface of the weight scale body, and operably configured to convert the weight to one of a plurality of non-weight identifying electronic symbols uniquely associated with the weight and operably configured to display the non-weight identifying electronic symbol to the electronic display;
providing a secondary electronic computing device with an electronic display configured to display a user interface;
measuring a user weight from the user with the weight scale, converting the user weight to the one of the plurality of non-weight identifying electronic symbols uniquely associated with the user weight, and displaying the one of the plurality of non-weight identifying electronic symbols on the electronic display of the weight scale;
electronically communicating the one of the plurality of non-weight identifying electronic symbols to the secondary electronic computing device; and
inserting the one of the plurality of non-weight identifying electronic symbols into the user interface, decoding the one of the plurality of non-weight identifying electronic symbols into a decoded user weight, and displaying the decoded user weight on the user interface.

2. The method according to claim 1, further comprising:
providing the weight scale body with a substantially planar upper surface with the electronic display disposed thereon.

3. The method according to claim 1, wherein each of the plurality of non-weight identifying electronic symbols further comprise at least one of a combination of numbers, a combination of letters, an alphanumerical combination, and a visually perceivable image.

4. The method according to claim 1, further comprising:
decoding the one of the plurality of non-weight identifying electronic symbols into the decoded user weight with at least one of a processor resident on the secondary electronic computing device and a processor on a remote server; and
storing the decoded user weight on at least one of a memory resident on the secondary electronic computing device and a memory resident on the remote server.

5. The method according to claim 1, further comprising:
providing a user electronic computing device communicatively coupled to the secondary electronic computing device over a network and having an electronic display and a user interface;
inserting the one of the plurality of non-weight identifying electronic symbols in the user interface of the user electronic computing device; and
electronically communicating the one of the plurality of non-weight identifying electronic symbols from the user electronic computing device to the secondary electronic computing device.

6. The method according to claim 5, further comprising:
storing a plurality of decoded user weights on the at least one of the memory resident on the secondary electronic computing device and the memory resident on the remote server, the secondary electronic computing device operably configured to display a categorized inventory of the plurality of decoded user weights on the user interface of the secondary electronic computing device.

7. The method according to claim 1, further comprising:
providing the weight scale having a networking interface communicatively coupling the weight scale to the electronic computing device through a network; and
electronically communicating the one of the plurality of non-weight identifying electronic symbols from the weight scale to the electronic computing device.

8. A specialized blind weight scale comprising:
a scale body having an upper surface and at least one lower surface configured to support the scale body on a ground surface;
an electronic display disposed on the upper surface of the scale body;
a weight sensor operably configured to ascertain a weight of an object supported on the upper surface of the weight scale body; and
a processor and a memory storing a computer readable instructions for converting the weight to a unique non-weight identifying electronic symbol, the processor operably configured to convert the weight to the unique non-weight identifying electronic symbol and display the unique non-weight identifying electronic symbol on the electronic display of the scale body.

9. The specialized blind weight scale according to claim 8, further comprising:
a networking interface operably configured to communicatively couple the weight scale to an electronic computing device through a network, the processor operably configured to electronically communicate the unique non-weight identifying electronic symbol to the electronic computing device through the network.

10. The specialized blind weight scale according to claim 8, wherein the weight scale body further comprises:
a substantially planar upper surface with the electronic display disposed thereon.
